(19) United States
(12) Patent Application Publication
(10) Pub. No.: US 2024/0336849 A1
(43) Pub. Date: Oct. 10, 2024

(54) MOBILE BIODIESEL MANUFACTURING PLANT FOR CONTINUOUSLY PRODUCING BIODIESEL FROM A TRIGLYCERIDE SOURCE

(71) Applicant: 34MJ Pty Ltd, Happy Valley (AU)

(72) Inventor: Morgan Hunter, Happy Valley (AU)

(21) Appl. No.: 18/627,795

(22) Filed: Apr. 5, 2024

(30) Foreign Application Priority Data
Apr. 6, 2023 (AU) 2023901014

(51) Int. Cl. C10G 3/00; B01J 19/00

(52) U.S. Cl. CPC C10G 3/44; B01J 19/008; C10G 2300/4012; C10G 2300/4068; C10G 2400/04

(57) ABSTRACT

A mobile biodiesel manufacturing plant for continuously producing biodiesel from a triglyceride source and a method of continuously producing biodiesel from a triglyceride source in the mobile biodiesel manufacturing plant.

### PRIORITY CLAIM

This application claims the benefit of and priority to Australian Patent Application No. 2023901014, filed on Apr. 6, 2023, the entire contents of which is incorporated by reference herein.

### TECHNICAL FIELD

The present disclosure relates to a mobile biodiesel manufacturing plant for continuously producing biodiesel from a triglyceride source and a method of continuously producing biodiesel from a triglyceride source in the mobile biodiesel manufacturing plant. Particularly, but not exclusively, the mobile biodiesel manufacturing plant has a housing in the form of a shipping container and is adapted to be transported to a production site.

### BACKGROUND

Biodiesel is a diesel fuel produced from a triglyceride source, such as vegetable oils or animal fats, consisting of long-chain fatty acid esters. Biodiesel fuel is compatible with fossil-derived diesel fuel and most diesel engines can operate on a blend of biodiesel and diesel.

The chemical process to produce biodiesel is transesterification which is the process of exchanging the organic functional group of an ester with the organic group of an alcohol in a chemical reaction in the presence of a catalyst. This reaction is currently generally carried out in the presence of sodium or potassium hydroxide as catalyst in a reactor.

This transesterification reaction generally comprises a triglyceride source, such as vegetable oil, and methanol being fed into the reactor and the solution being subjected to relatively high pressure and relatively high temperature. The relatively high pressure and temperatures required, however, require relatively large and generally not very portable equipment. Also, the relatively high temperatures and pressures may cause safety issues.

It would be desirable to provide a mobile biodiesel manufacturing plant for continuously producing biodiesel from a triglyceride source that ameliorates or addresses one or more of these challenges and provides advantages over certain known biodiesel manufacturing plants.

The above discussion of documents, acts, materials, devices, articles and the like, is comprised in the specification for the purpose of providing a context for the present disclosure. It is not suggested or represented that these matters formed part of the prior art base or were common general knowledge in the field relevant to the present disclosure as it existed before the priory date of each claim in this application.

### SUMMARY

One aspect of the present disclosure is a mobile biodiesel manufacturing plant for continuously producing biodiesel from a triglyceride source, the plant comprising: a housing adapted to be transported to a production site for continuously producing biodiesel; a mixing chamber located within the housing adapted to: receive triglycerides from a triglyceride source container; receive a catalyst mixture containing potassium or sodium methoxide and methanol at a potassium or sodium hydroxide concentration of up to 32% by weight from a catalyst container; and mix the triglycerides, methanol and the catalyst mixture to derive a solution without heating the solution; a reactor located within the housing adapted to: receive the solution from the mixing chamber; and subject the triglycerides in the solution to a transesterification reaction with said methanol in the presence of said potassium or sodium hydroxide as a catalyst under ultrasonic cavitation conditions in the reactor at a pressure of 1 to 3 bar; a vortex multiplier tank located within the housing adapted to: receive the solution from the reactor; and continually agitate the solution for between 30 and 60 minutes to complete the transesterification reaction to convert the triglycerides into glycerine and biodiesel; and two or more cascading tanks located within the housing adapted to: separate the glycerine from the biodiesel in the solution by decanting the solution under gravity; and output the biodiesel to a biodiesel storage container.

Another aspect of the present disclosure is a method of continuously producing biodiesel from a triglyceride source in a mobile biodiesel manufacturing plant having a housing adapted to be transported to a production site, comprising: receiving triglycerides in a mixing chamber located within the housing of the plant from a triglyceride source container; receiving a potassium or sodium methoxide mixture of potassium or sodium hydroxide and methanol in the mixing chamber at a potassium or sodium hydroxide concentration of up to 32% by weight from a catalyst container; mixing the triglycerides, methanol and potassium or sodium methoxide mixture in the mixing chamber to derive a solution without heating the solution; subjecting the triglycerides to a transesterification reaction with said methanol in the presence of said potassium or sodium hydroxide as a catalyst under ultrasonic cavitation conditions in a reactor located within the housing at a pressure of 1 to 3 bar; receiving the solution from the reactor in a vortex multiplier tank located within the housing and continually agitating the solution in the vortex multiplier tank for between 30 and 60 minutes to complete the transesterification reaction to convert the triglycerides into glycerine and biodiesel; separating the glycerine from the biodiesel in the solution by decanting the solution under gravity in two or more cascading tanks located within the housing; and outputting the biodiesel to a biodiesel storage container.

In one embodiment, the housing is a shipping container. The plant can thus be portable, and transportable, via use of the shipping container.

The triglyceride source may be a feed stock, such as canola, mustard or safflower. Alternatively, the triglyceride source may be a vegetable oil, such as soybean oil, sunflower oil, rape seed oil, corn oil, cotton oil, palm oil, waste vegetable oil, other plant-based oils, and other high FFA oils from waste streams. These triglyceride sources are generally not required to be pre-treated, such as via acid washing and water washing.

The biodiesel produced by the mobile biodiesel manufacturing plant is biodiesel fuel, which is generally prepared from vegetable oils and may be used in place of diesel fuel for engines.

In one embodiment, the mixing chamber is further configured to receive methanol at a concentration above 98.5% by weight from a methanol container.

In one embodiment, the mixing chamber comprises a static flow mixer to mix the triglycerides, methanol and potassium or sodium methoxide in the mixing chamber. That is, the mixing chamber is a pre-mixing step to mix the solution of triglyceride, methanol and methoxide before entering the reactor to improve the reaction. No additional pre heating of triglycerides or methanol mixtures is required.

In one embodiment, the reactor comprises an ultrasonic cavitation cell disposed centrally within the reactor adapted to generate the ultrasonic cavitation conditions. The ultrasonic cavitation cell may have 2 to 10 reaction faces adapted to generate the ultrasonic cavitation conditions. Further, the ultrasonic cavitation cell may not be uniform in shape and or have fluctuating ultrasonic amplitude to generate improved ultrasonic cavitation conditions.

In one embodiment, the reactor further comprises an exit port located at the top of the reactor adapted to restrict flow of the solution to the vortex multiplier tank to provide the pressure of 1 to 3 bar in the reactor. This pressure is generally less than conventional reactors. Also, the fluid in the reactor flows through the reactor around the ultrasonic cavitation cell. The size of the reactor is generally configured or designed according to the desired flow through the reactor.

As mentioned before, cavitation is a process for producing biodiesel, but the operative conditions and the equipment used previously have not provided fully satisfactory results and have had to be on a relative large scale to be a viable process at relative lower temperatures.

In one embodiment, the vortex multiplier tank comprises a pump or impeller to keep the solution in suspension. The solution can thus undergo a continual reaction as no glycerine can fall out of the vortex multiplier tank.

In one embodiment, the solution enters the top of the vortex multiplier tank, and the pump or impeller forces the solution towards a middle of the vortex multiplier tank, and the solution exits the vortex multiplier tank at the bottom of the vortex multiplier tank under gravity when the vortex multiplier tank is full. That is, the vortex multiplier tank provides vortex and shear mixing for a desired time.

The Applicant has found that the above process for producing biodiesel, by ultrasonic cavitation technology, can produce a triglyceride conversion above 96.0% by weight. This conversion value of triglycerides in biodiesel is obtained in part by allowing the chemical reaction initiated in the cavitation reactor to end in the vortex multiplier tank, which is an agitated-tank-type reactor, downstream from the cavitation reactor.

In one embodiment, the two or more cascading tanks are further adapted to output the glycerine to a glycerine storage container.

In one embodiment, the solution is received in a first one of the two or more cascading tanks, where the glycerine separates from the biodiesel and collects at the bottom of the first one of the cascading tanks, and the biodiesel cascades to a second one of the two or more cascading tanks from the top of the first one, where the second one of the two or more cascading tanks acts as a settling zone for the biodiesel. The cascading tanks operate with minimal energy and continual flow to automatically remove glycerine from the tanks. The cascading tanks separate the articles from the liquids and generally works up to a 50:50 ration of biodiesel to glycerine. As with the reactor, the size of the tanks is generally designed according to the desired flow through the tanks.

In one embodiment, the plant further comprises a plurality of filters located within the housing and adapted to receive the biodiesel from the two or more cascading tanks and filter the biodiesel before outputting to the biodiesel storage container.

In one embodiment, the plurality of filters comprises: a pre-filter, lead column filter, lag column filter, and a polishing filter.

In one embodiment, the plant further comprises a controller having a process control unit (PCU) configured to operate pumps in the plant to produce the biodiesel.

In one embodiment, the plant further comprises a biodiesel pump adapted to draw the biodiesel from the two or more cascading tanks and pump the biodiesel through the filters, and a biodiesel flow sensor adapted to sense flow of the biodiesel to the biodiesel storage container.

In one embodiment, the PCU is configured to: receive a signal from the biodiesel flow sensor; determine when the filters require changing based on the signal; and output a notification to a maintenance device to change the filters.

In one embodiment, the PCU is further configured to control the pump or impeller to keep the solution in suspension in the vortex multiplier tank for a designated time between 30 and 60 minutes.

In one embodiment, the plant further comprises an oil pump adapted to draw the triglycerides from the triglyceride source container into the mixing chamber and a catalyst pump adapted to draw the potassium or sodium methoxide mixture of potassium or sodium hydroxide and methanol from the catalyst container into the mixing chamber.

In one embodiment, the plant further comprises an oil sensor adapted to sense flow of the triglycerides to the mixing chamber, and a catalyst sensor adapted to sense flow of the mixture of potassium or sodium hydroxide and methanol to the mixing chamber, wherein the PCU is further configured to control the oil pump and the catalyst pump to provide the triglycerides, methanol and potassium or sodium methoxide mixture in the mixing chamber at a designated ratio based on received signals from the oil sensor and the catalyst sensor.

In one embodiment, the plant further comprises a methanol sensor adapted to sense flow of the methanol to the mixing chamber, wherein the PCU is further configured to control the catalyst pump and the methanol pump to provide the methanol and potassium or sodium methoxide mixture in the mixing chamber at the designated ratio of around 32% by weight based on received signals from the methanol sensor and the catalyst sensor.

### BRIEF DESCRIPTION OF DRAWINGS

Embodiments of the present disclosure will now be described in greater detail with reference to the accompanying drawings, in which:

FIG. 1 is a schematic diagram of a mobile biodiesel manufacturing plant for continuously producing biodiesel from a triglyceride source according to an embodiment of the present disclosure;

FIG. 2 is a flow chart of a method of continuously producing biodiesel from a triglyceride source according to an embodiment of the present disclosure;

FIG. 3 is a sectional view of a mobile biodiesel manufacturing plant for continuously producing biodiesel from a triglyceride source according to an embodiment of the present disclosure;

FIG. 4 is a view of a reactor of the mobile biodiesel manufacturing plant of FIG. 3;

FIG. 5 is a view of a vortex multiplier tank and two cascading tanks of the mobile biodiesel manufacturing plant of FIG. 3; and

FIG. 6 is a view of filters of the mobile biodiesel manufacturing plant of FIG. 3.

### DETAILED DESCRIPTION

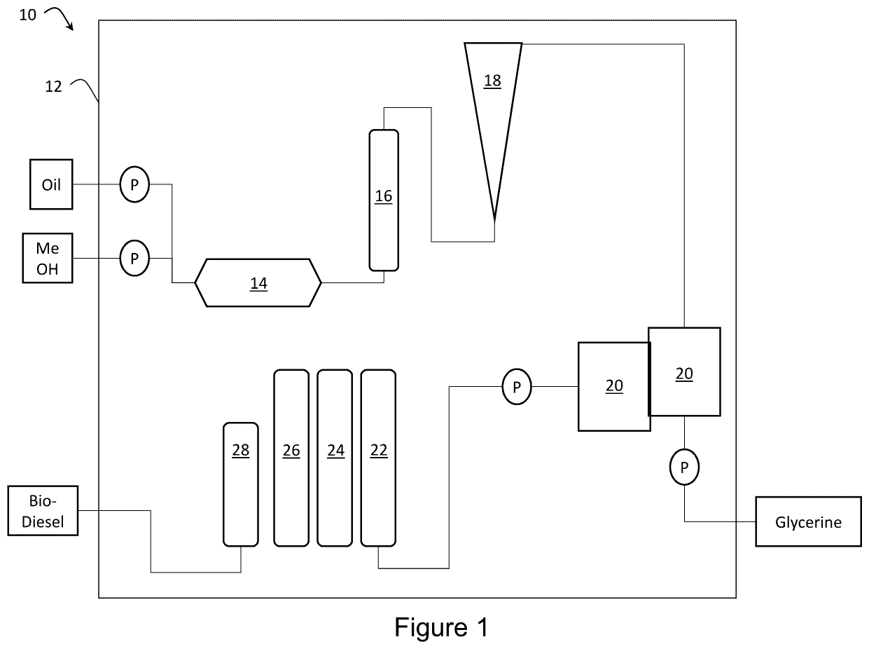

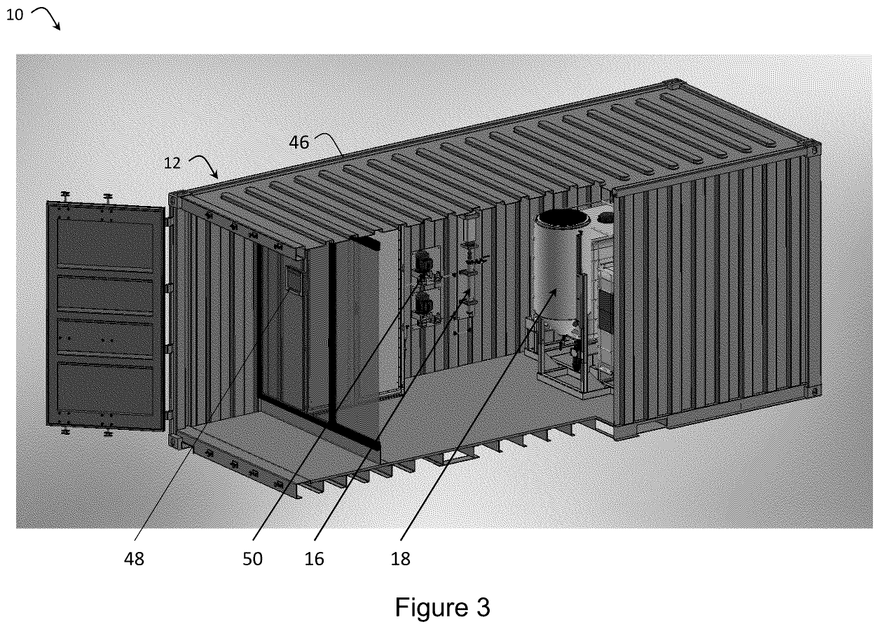

An embodiment of a mobile biodiesel manufacturing plant 10 configured to continuously produce biodiesel from a triglyceride source is described below with reference to FIG. 1. The plant comprises a housing 12 configured to be transported to a production site for continuously producing biodiesel. As mentioned, the housing 12 in an embodiment is a shipping container 46, as shown in FIG. 3, which is transportable to a production site. The shipping container may also be temperature controlled at a temperature of around 25° C.

The housing 12 contains a mixing chamber 14 configured to: receive triglycerides from a triglyceride source container, labelled Oil, not located within the housing 12 and receive a catalyst mixture containing potassium or sodium methoxide and methanol at a potassium or sodium hydroxide concentration of up to 32% by weight, labelled MeOH, from a catalyst container also not located within the housing 12.

The MeOH and the Oil are pumped into the mixing chamber 14 which is a static flow mixer configured to mix the Oil and MeOH mixture to derive a solution that is pumped into a reactor 16 that is also located within the housing 12. No heat is required to be applied to the Oil and the MeOH liquid.

The triglyceride concentration of the Oil is above 96.0% by weight. The catalyst concentration of MeOH is 0.7 to 2% by weight of sodium or potassium hydroxide and, in certain embodiments, 1.5% potassium hydroxide. Chemical reaction stoichiometry: 1 mole triglyceride per 3.5 to 4.5 moles methanol or ethanol.

The reactor 16 is configured to receive the solution from the mixing chamber 14 and subject the Oil in the solution to a transesterification reaction with methanol in the presence of potassium hydroxide as a catalyst in the MeOH under ultrasonic cavitation conditions in the reactor at a pressure of 1 to 3 bar and, in certain embodiments, 1.8 bar. Residence time in the reactor 14 is 5 to 30 seconds. The reactor 16 is made from chemical resistant material with poor conductivity to keep energy within the reactor 16.

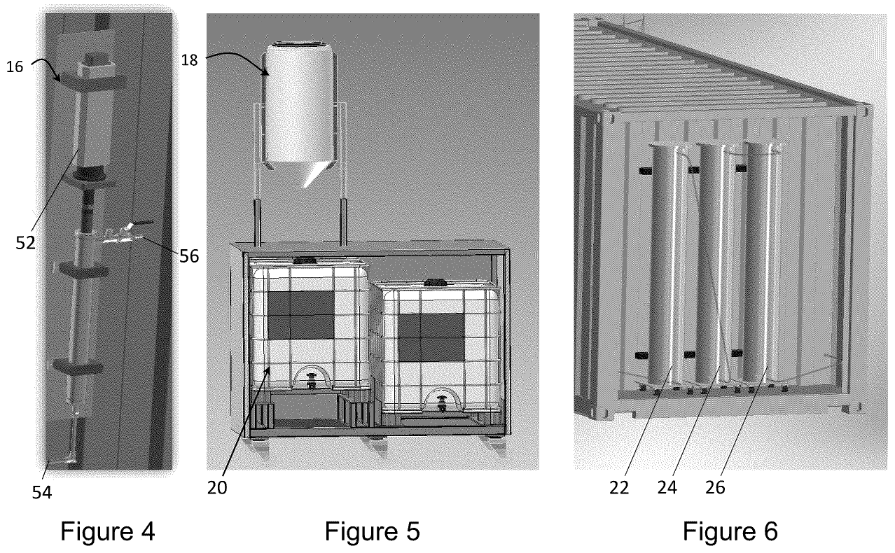

The reactor 16 further comprises an ultrasonic cavitation cell 52 (or probe), shown in in part in FIG. 4, disposed centrally within the reactor 16 configured to generate the ultrasonic cavitation conditions. In certain embodiments, the ultrasonic cavitation cell has 2 to 10 reaction faces configured to generate the ultrasonic cavitation conditions. That is, sono-probes from the ultrasonic cell 52 are mounted within the reactor 16. These probes are customised for the reactor 16 and for flow through the reactor 16. The cavitation cell 52 is tubular and enables the fluid to flow over around the reaction faces of the cavitation cell 52. Power consumption for such a reactor may be 13 to 26 watts per litre of biodiesel produced.

During the cavitation process, as the solution passes through the reactor 16, the generated energy forms vapour bubbles of the solution which then collapse. Within the bubbles, pressure reaches 40,000 psi and temperature reaches 10,000° C., because the phenomenon occurs at a molecular level since the outer temperature is just 3 to 5 degrees above the solution inlet temperature and the pressure virtually does not vary.

A vortex multiplier tank 18 also located within the housing 12 is configured to receive the solution from the reactor 16 and continually agitate the solution for between 30 and 60 minutes to complete the transesterification reaction to convert the triglycerides into glycerine and biodiesel.

That is, the vortex multiplier tank 18 is a resonance tank that acts as a time delay, keeping the mixture in suspension. 90% of the glycerine will typically fall out of suspension within 10 mins. Keeping the glycerine suspended keeps the reaction occurring in the vortex multiplier tank 18 and ensures all the Oil is reacted.

The vortex multiplier tank 18 comprises a pump or impeller to keep the solution in suspension. The solution enters the top of the vortex multiplier tank 18, shown in FIG. 5, and the pump or impeller forces the solution towards a middle of the vortex multiplier tank 18, and the solution exits the vortex multiplier tank 18 at the bottom of the tank under gravity when the tank is full to cascading tanks 20 to separate the glycerine from the biodiesel in the solution. That is, liquid enters the tank 18 at the top but is forced to mid-way down to ensure that the liquid spends some time within the tank 18 and, when the tank 18 is full, the new liquid forces out the old liquid via gravity

The reactor 16 shown in FIG. 4 further comprises an exit port 56 located at the top of the reactor 16 configured to restrict flow of the solution to the vortex multiplier tank 18 to provide the pressure of 1 to 3 bar in the reactor 16.

The reactor 16 is configured or designed to ensure adequate reaction to the Oil and MeOH and the volume of the reactor is dictated by the flow and required energy not the reactor 16. Under these operative conditions, a triglyceride conversion above 96.0% by weight, by weight is obtained at the agitated-tank-type reactor outlet. The Applicant notes that these triglyceride conversion values, which in practice represent a complete conversion of triglycerides in biodiesel, have been obtained neither by conventional technologies nor by the ultrasonic cavitation technology used hitherto without the use of at least additional heat.

Moreover, these results derived from the above-mentioned combinations of temperature and pressure and operative conditions in the reactor 16, which are substantially different from the values used in the state of the art, and from the application of a prior art single-cell cavitation reactor chamber.

In particular, the reaction temperature decrease below the usual 65 to 70° C., to values ranging from 20 to 30° C., and, in certain embodiments, about 25° C., together with the low pressure of 1 to 5 bar in the cavitation reactor lower than other cavitation processes which are usual between 10 to 30 bar, together with the use of an ultrasonic cavitation tubular reactor where the liquid flows around the probe, for obtaining such high results in the conversion of triglyceride (above 96.0% by weight) in biodiesel, are relatively surprising and unexpected results.

Two or more cascading tanks 20 are located within the housing 12 and are configured to separate the glycerine from the biodiesel in the solution by decanting the solution under gravity and output the biodiesel to a biodiesel storage container, labelled Bio-Diesel, not located within the housing 12. Also, the cascading tanks 20 output the glycerine to a glycerine tank, labelled Glycerine, also not located within the housing 12. That is, the solution flows in the tanks 20 until glycerine is removed and then biodiesel is purified by filters 22 24 26 28. Specifically, the solution is received in a first of two cascading tanks 20, shown as the left tank in FIG. 5, where the glycerine separates from the biodiesel and collects at the bottom of the first tank 20, and the biodiesel cascades to a second cascading tank 20, shown as the right tank in FIG. 5, from the top of the first one, where the second tank 20 acts as a settling zone for the biodiesel and a reservoir for filters of the biodiesel.

The glycerine is pumped from the first tank 20 to the Glycerine container via a pump. The biodiesel from the second tank 20 is pumped via a pump through filters, in the form of cellulose material and exchange resins, and afterwards a polishing filter, to yield pure biodiesel fuel. No distillation or methanol/water recovery is required. That is, the filters comprise a pre-filter 22, lead column filter 24, lag column filter 26, and a polishing filter 28. FIG. 6 shows the pre-filter 22, lead column filter 24 and lag column filter 26. The biodiesel goes from one filter to the next until its ready to be outputted. The filter columns are individually replaceable to ensure minimal downtime.

FIG. 3 shows the mobile biodiesel manufacturing plant 10 configured to continuously produce biodiesel housed within the shipping container 46 comprising a controller having a process control unit (PCU) 48 configured to at least operate pumps 50 in the plant 10 to pump Oil and MeOH into the mixing chamber 14 to ultimately produce the biodiesel. The reaction chamber 16 and the vortex multiplier tank 18 can also be seen in this Figure.

It will be appreciated that the PCU 48 can be configured to operate all the pumps/impellers in the plant 10. The pumps utilise industrial motors and controllers driving external gear pumps to operate, and the controllers are controlled by the PCU. For instance, the PCU 48 is configured to control the pump or impeller to keep the solution in suspension in the vortex multiplier tank 18 for a designated time between 30 and 60 minutes.

The PCU 48 is also configured to receive a signal from a biodiesel flow sensor and to determine when the filters 22 24 26 28 require changing based on the signal and output a notification to a maintenance device to change the filters. Further, if the filters are not changed in an allocated time, the PCU will turn off the plant 10 and management can be notified. The biodiesel flow sensor is also used by the PCU 48 to meter the flow of biodiesel and tally how much is produced.

In an embodiment, the plant 10 comprises an oil sensor configured to sense flow of the triglycerides (Oil) to the mixing chamber container 14, and a potassium methoxide sensor configured to sense flow of the mixture of potassium hydroxide and methanol (MeOH) to the mixing chamber. The sensor may measure flow with a gear flow sensor which uses a Hall effect sensor.

In this embodiment, the PCU 50 is further configured to control the oil pump and the potassium methoxide pump to provide the triglycerides, methanol and potassium methoxide mixture in the mixing chamber at a designated ratio based on received signals from the oil sensor and the potassium methoxide sensor.

In another embodiment, the mixing chamber 14 is further configured to receive methanol at a concentration above 98.5% by weight from a methanol container not located in the shipping container 26. In this embodiment, the plant further comprises a methanol sensor configured to sense flow of the methanol to the mixing chamber container 14, and the PCU 510 is further configured to control the potassium methoxide pump and the methanol pump to provide the methanol and potassium methoxide mixture in the mixing chamber 14 at the designated ratio of around 32% by weight based on received signals from the methanol sensor and the potassium methoxide sensor.

The PCU 48 has a touch screen interface to assist a user in operating the controller of the plant 10. The PCU is remote monitored and continually calibrated. That is, periodically, the outputted biodiesel is tested and the controller is updated if required by the user via the PCU 48. Also, the Oil is tested prior to use by the plant 10 and results of the test are inputted into the PCU to adapt parameters of the above described process to suit the particular Oil undergoing the process to produce biodiesel.

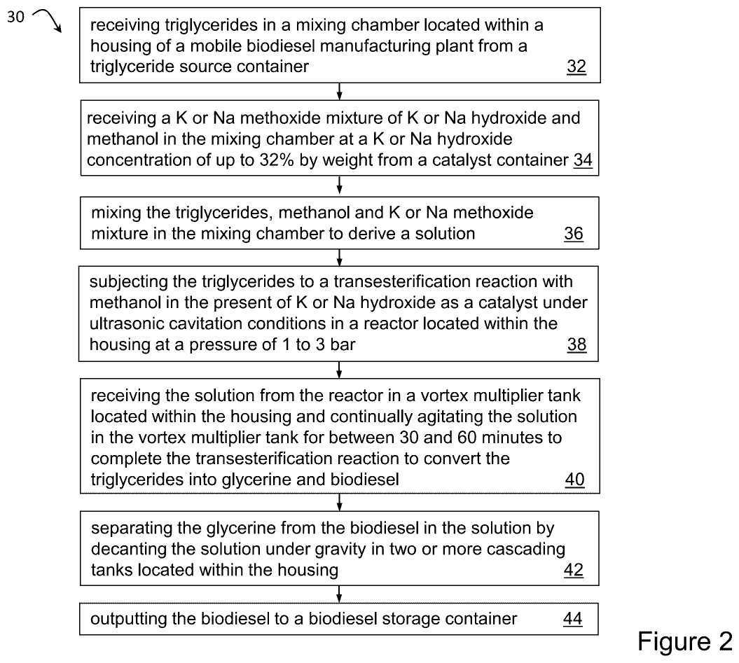

FIG. 2 shows a summary of a method 30 of continuously producing biodiesel from a triglyceride source in a mobile biodiesel manufacturing plant 10, as described above, having a housing 12 adapted to be transported to a production site.

The method 30 comprises: receiving 32 triglycerides in a mixing chamber located within the housing of the plant from a triglyceride source container; receiving 34 a potassium methoxide mixture of potassium hydroxide and methanol in the mixing chamber at a potassium hydroxide concentration of around 32% by weight from a potassium methoxide container; mixing 36 the triglycerides, methanol and potassium methoxide mixture in the mixing chamber to derive a solution; subjecting 38 the triglycerides to a transesterification reaction with said methanol in the presence of said potassium hydroxide as a catalyst under ultrasonic cavitation conditions in a reactor located within the housing at a pressure of 1 to 3 bar; receiving 40 the solution from the reactor in a vortex multiplier tank located within the housing and continually agitating the solution in the vortex multiplier tank for between 30 and 60 minutes to complete the transesterification reaction to convert the triglycerides into glycerine and biodiesel; separating 42 the glycerine from the biodiesel in the solution by decanting the solution under gravity in two or more cascading tanks located within the housing; and outputting 44 the biodiesel to a biodiesel storage container.

It will be appreciated by those persons skilled in the art that further features of the method 30 will be apparent from the description of the plant 10. Further, the persons skilled in the art will also appreciate that at least part of the method 30 could be embodied in program code that is implemented by the controller and the PCU 48.

The program code could be supplied in a number of ways, such as on a memory in data communication with the controller. The controller in the embodiment includes the PCU 48, which includes a microprocessor that is configured to execute one or more algorithms stored in an associated memory, such as RAM and/or ROM (not shown), to perform the method 30.

### Application Example

The method 30 of producing biodiesel was carried out in a laboratory. In the example, an ultrasonic unit, called UIP1000hdT, provided by Hielscher, was used.

A batch of 1000 L cold pressed mustard seed oil was used as raw material, with a density of about 0.92 Kg/L with a Free Fatty Level of 2%.

In the transesterification step, potassium hydroxide was used as catalyst (1.5% by weight compared to the total amount of oil plus alcohol). Advantageously, this type of catalyst enables working under relatively low temperature conditions, below the normal methanol boiling temperature. Technical grade methanol was used with purity above 98.5% by weight.

Since the free fatty acids contained in the starting oil are not esterified during the transesterification process, this will result in lowing the final purity level.

The final steps of the complete process, following the transesterification step, consisted in separating biodiesel fuel from the remaining by products, especially the residual glycerine.

Thus, the transesterification process was followed by glycerine separation, which is insoluble in methyl esters. In conventional processes, this is usually carried out with the use of centrifugal force. Besides, methanol excess, catalyst residues, and soap generated as by-products had to be removed, as well as the non-esterified free fatty acids.

In the example, the complete process for obtaining biodiesel from mustard seed oil comprised the following steps:
Oil decantation and filtered;
Transesterification by ultrasonic cavitation using an ultrasonic transducer UIP1000hdT, provided by Hielscher, followed by a product agitation process in a tank for 60 minutes to complete the transesterification reaction;
Glycerine separation by a continuous flow cascade separator;
Biodiesel purification by lead cellulose column followed supplied by Eco2Pure followed by a lead and Lag column setup with PD206 ion exchange resins from Purolite; and
Biodiesel drying by polishing filters.

### Transesterification

At the input of the ultrasonic cavitation process, the feed, composed of a volumetric flow of 175.5 L/h and 83% mustard oil with purity above 98.0% by weight and 17% by weight of methanol, was not heated prior to being reacted, this was obtained at operating at temperatures of 22 to 26° C.

The required work pressure for obtaining the desired conversion level was set at 1.4 bar.

The resulting product was continuously fed into reactor chamber, at the same temperature, and flowed into the vortex multiplier tank to enable the completion of the transesterification reaction.

The product obtained in the reactor outlet basically consisted in a biodiesel and glycerine blend, with 97.5% by weight of triglyceride conversion, compared to the triglyceride weight in the cavitation reactor inlet.

### Glycerine Separation

This separation step of glycerine from biodiesel was carried out in a continuous flow cascade separator with a total volume of 1500 L.

The glycerine-free biodiesel was processed using Eco2Pure and PD206 resins. Unlike conventional processes, when using the PD206 resin, it is not necessary to previously dealcoholize the biodiesel to be purified. This is possible due to the amount of methanol used in this transesterification process, which enbles using up to 50% less of methanol than conventional processes.

The amount of Eco2Pure material needed for this process is 30 kg and 50 L of PD206 resin. The use of the Eco2Pure and PD206 exchange resin for biodiesel purification, and the Subsequent removal of Soap, glycerine residues, methanol, and impurities replace washes with acidic water and neutral water used in conventional processes.

The column size was calculated depending on the flow per hour of the product to be purified. Out of the total volume of the column, 50% was left empty, since the resin, as it retains soaps, glycerine, and impurities, swells until it completely fills the column volume.

### Filters

Finally, in this step, the substantially pure biodiesel was subject to polishing filters to remove possible water and residues.

By the end of the purification train, 998 L biodiesel were obtained, which complied with the international standard requirements. The total power consumed 13,000 Watts which equates to 13 Watts/L used.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, integers steps, operations, elements, and/or components, but do not preclude the presence or addition of one or more other features, integers steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Finally, it is evident that variations can be made to the described embodiment of the present disclosure without departing from the scope of the following claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention claimed is:

1. A mobile biodiesel manufacturing plant configured to continuously produce biodiesel from a triglyceride source, the plant comprising:
a housing transportable to a production site for continuously producing biodiesel;
a mixing chamber located within the housing and configured to:
receive triglycerides from a triglyceride source container;
receive a catalyst mixture containing potassium or sodium methoxide and methanol at a potassium or sodium hydroxide concentration of up to 32% by weight from a catalyst container; and
mix the triglycerides, methanol and the catalyst mixture to derive a solution without heating the solution;
a reactor located within the housing and configured to:
receive the solution from the mixing chamber; and
subject the triglycerides in the solution to a transesterification reaction with said methanol in the presence of said potassium or sodium hydroxide as a catalyst under ultrasonic cavitation conditions in the reactor at a pressure of 1 bar to 3 bar;
a vortex multiplier tank located within the housing and configured to:
receive the solution from the reactor; and
continually agitate the solution for between 30 minutes and 60 minutes to complete the transesterification reaction to convert the triglycerides into glycerine and biodiesel; and
two or more cascading tanks located within the housing and configured to:
separate the glycerine from the biodiesel in the solution by decanting the solution under gravity; and
output the biodiesel to a biodiesel storage container.

2. The mobile biodiesel manufacturing plant of claim 1, wherein the housing is a shipping container.

3. The mobile biodiesel manufacturing plant of claim 1, wherein the mixing chamber is further configured to receive methanol at a concentration above 98.5% by weight from a methanol container.

4. The mobile biodiesel manufacturing plant of claim 3, wherein the mixing chamber comprises a static flow mixer to mix the triglycerides, methanol and potassium or sodium methoxide in the mixing chamber.

5. The mobile biodiesel manufacturing plant of claim 1, wherein the reactor comprises an ultrasonic cavitation cell disposed centrally within the reactor and configured to generate the ultrasonic cavitation conditions.

6. The mobile biodiesel manufacturing plant of claim 5, wherein the ultrasonic cavitation cell has 2 reaction faces to 10 reaction faces which are configured to generate the ultrasonic cavitation conditions.

7. The mobile biodiesel manufacturing plant of claim 5, wherein the reactor further comprises an exit port located at the top of the reactor and configured to restrict flow of the solution to the vortex multiplier tank to provide the pressure of 1 bar to 3 bar in the reactor.

8. The mobile biodiesel manufacturing plant of claim 1, wherein the vortex multiplier tank comprises a pump or impeller to keep the solution in suspension.

9. The mobile biodiesel manufacturing plant of claim 8, wherein the solution enters the top of the vortex multiplier tank, and the pump or impeller forces the solution towards a middle of the vortex multiplier tank, and the solution exits the vortex multiplier tank at the bottom of the vortex multiplier tank under gravity when the vortex multiplier tank is full.

10. The mobile biodiesel manufacturing plant of claim 1, wherein the two or more cascading tanks are further configured to output the glycerine to a glycerine storage container.

11. The mobile biodiesel manufacturing plant of claim 10, wherein the solution is received in a first one of the two or more cascading tanks, where the glycerine separates from the biodiesel and collects at the bottom of the first one of the cascading tanks, and the biodiesel cascades to a second one of the two or more cascading tanks from the top of the first one, where the second one of the two or more cascading tanks acts as a settling zone for the biodiesel.

12. The mobile biodiesel manufacturing plant of claim 1, further comprising a plurality of filters located within the housing and configured to receive the biodiesel from the two or more cascading tanks and filter the biodiesel before outputting to the biodiesel storage container.

13. The mobile biodiesel manufacturing plant of claim 12, wherein the plurality of filters comprises: a pre-filter, lead column filter, lag column filter, and a polishing filter.

14. The mobile biodiesel manufacturing plant of claim 1, further comprising a controller having a process control unit configured to operate pumps in the plant to produce the biodiesel.

15. The mobile biodiesel manufacturing plant of claim 14, further comprising a biodiesel pump configured to draw the biodiesel from the two or more cascading tanks and pump the biodiesel through the filters, and a biodiesel flow sensor configured to sense flow of the biodiesel to the biodiesel storage container.

16. The mobile biodiesel manufacturing plant of claim 15, wherein the process control unit is configured to: receive a signal from the biodiesel flow sensor; determine when the filters require changing based on the signal; and output a notification to a maintenance device to change the filters.

17. The mobile biodiesel manufacturing plant of claim 14, further comprising a plurality of filters located within the housing and configured to receive the biodiesel from the two or more cascading tanks and filter the biodiesel before outputting to the biodiesel storage container, wherein the vortex multiplier tank comprises a pump or impeller to keep the solution in suspension, and wherein the process control unit is further configured to control the pump or impeller to keep the solution in suspension in the vortex multiplier tank for a designated time between 30 minutes and 60 minutes.

18. The mobile biodiesel manufacturing plant of claim 17, further comprising an oil pump configured to draw the triglycerides from the triglyceride source container into the mixing chamber and a catalyst pump configured to draw the potassium or sodium methoxide mixture of potassium or sodium hydroxide and methanol from the catalyst container into the mixing chamber.

19. The mobile biodiesel manufacturing plant of claim 18, further comprising an oil sensor configured to sense flow of the triglycerides to the mixing chamber, and a catalyst sensor configured to sense flow of the mixture of potassium or sodium hydroxide and methanol to the mixing chamber, wherein the process control unit is further configured to control the oil pump and the catalyst pump to provide the triglycerides, methanol and potassium or sodium methoxide mixture in the mixing chamber at a designated ratio based on received signals from the oil sensor and the catalyst sensor.

20. The mobile biodiesel manufacturing plant of claim 19, wherein the mixing chamber is further configured to receive methanol at a concentration above 98.5% by weight from a methanol container, and the mobile biodiesel manufacturing plant further comprising a methanol sensor configured to sense flow of the methanol to the mixing chamber, wherein the process control unit is further configured to control the catalyst pump and the methanol pump to provide the methanol and potassium or sodium methoxide mixture in the mixing chamber at the designated ratio of around 32% by weight based on received signals from the methanol sensor and the catalyst sensor.

21. A method of continuously producing biodiesel from a triglyceride source in a mobile biodiesel manufacturing plant having a housing configured to be transported to a production site, the method comprising:
receiving triglycerides in a mixing chamber located within the housing of the plant from a triglyceride source container;
receiving a potassium or sodium methoxide mixture of potassium or sodium hydroxide and methanol in the mixing chamber at a potassium or sodium hydroxide concentration of up to 32% by weight from a catalyst container;
mixing the triglycerides, methanol and potassium or sodium methoxide mixture in the mixing chamber to derive a solution without heating the solution;
subjecting the triglycerides to a transesterification reaction with said methanol in the presence of said potassium or sodium hydroxide as a catalyst under ultrasonic cavitation conditions in a reactor located within the housing at a pressure of 1 bar to 3 bar;
receiving the solution from the reactor in a vortex multiplier tank located within the housing and continually agitating the solution in the vortex multiplier tank for between 30 minutes and 60 minutes to complete the transesterification reaction to convert the triglycerides into glycerine and biodiesel;
separating the glycerine from the biodiesel in the solution by decanting the solution under gravity in two or more cascading tanks located within the housing; and
outputting the biodiesel to a biodiesel storage container.
